(19) United States
(12) Patent Application Publication
(10) Pub. No.: US 2015/0172764 A1
(43) Pub. Date: Jun. 18, 2015

(54) APPARATUS AND METHOD FOR RECOMMENDING CONTENT, AND METHOD FOR DISPLAYING IMAGE

(71) Applicant: SAMSUNG ELECTRONICS CO., LTD., Suwon-si (KR)

(72) Inventors: Jae-ho CHAE, Suwon-si (KR); Jong-cheol PARK, Suwon-si (KR); Su-won SEO, Suwon-si (KR); Sang-hyup LEE, Suwon-si (KR)

(73) Assignee: SAMSUNG ELECTRONICS CO., LTD., Suwon-si (KR)

(21) Appl. No.: 14/327,052

(22) Filed: Jul. 9, 2014

(30) Foreign Application Priority Data
Dec. 18, 2013 (KR) 10-2013-0157788

(51) Int. Cl. H04N 21/466; H04N 21/45; H04N 21/431; H04N 21/482; H04N 21/4147; H04N 21/472; H04N 21/258; H04N 21/25

(52) U.S. Cl. CPC H04N 21/4668; H04N 21/25891; H04N 21/4532; H04N 21/4667; H04N 21/251; H04N 21/4826; H04N 21/4147; H04N 21/47202; H04N 21/4312; H04N 21/4316

(57) ABSTRACT

A content recommendation apparatus, a content recommendation method, and an image display method are provided. A content recommendation apparatus configured to connect to an image display apparatus includes: a viewing history analyzer configured collect viewing information of a user from the image display apparatus, generate a viewing history of the user, and analyze the generated viewing history; a content mapper configured to map recommended contents the user according to a result of the analyzing, and update the recommended contents, and an image former configured to generate images of the updated recommended contents, and provide the image display apparatus with the generated images in response to the user requesting the recommended contents.

### CROSS-REFERENCE TO RELATED APPLICATION(S)

This application claims priority from Korean Patent Application No. 10-2013-0157788, filed on Dec. 18, 2013, in the Korean Intellectual Property Office, the disclosure of which is incorporated herein by reference in its entirety.

### BACKGROUND

1. Field

Apparatuses and methods consistent with exemplary embodiments relate to an apparatus and a method for recommending content, and a method for displaying an image, and more particularly, to a content recommendation apparatus capable of recommending content of a program shown in the past, as well as at present and in the future, and also recommending content recorded using a personal video recorder (PVR) by a user, for example, when the television (TV) user requests recommended contents listed based on a user viewing history, a method for recommending content, and a method for displaying an image.

2. Description of the Related Art

Recently, contents that users can access have increased exponentially due to developments in transmission and storage technologies of audio video (AV) media. In particular, as digital broadcasting and high-speed internet infrastructure have been introduced and diverse AV devices with increased mass storage have been developed, users may enjoy watching numerous contents anywhere and at any time.

However, as the amount of contents has increased, it takes more time and effort for a user to search for content that the user wants. In order to solve this problem, effective interface technologies have been developed.

Accordingly, televisions (TVs) do not simply transmit broadcasts but also manage channels according to diverse broadcast signals and recommend contents based on a viewing history of viewers.

Related-art broadcast recommendation systems mostly recommend currently broadcast programs or subsequently broadcast programs. However, for the currently broadcast programs, the user may miss the beginning of the program, or for the subsequently broadcast programs, the user may have to wait until the broadcasting time of the program.

In addition, in the case of a related-art video-on-demand (VOD) service, the user has to search for a broadcast that the user wants by searching, for example, through a list of a corresponding broadcast service. Accordingly, the user has to perform inconvenient searches. Further, the user may have to perform a search where the user does not know information regarding the corresponding content.

### SUMMARY

Exemplary embodiments overcome the above disadvantages and other disadvantages not described above. Also, exemplary embodiments are not required to overcome the disadvantages described above, and an exemplary embodiment may not overcome any of the problems described above.

One or more exemplary embodiments provide a content recommendation apparatus capable of recommending content of a program shown in the past as well as at present and in the future, and also recommending content recorded using a personal video recorder (PVR) by a user, for example, when the television (TV) user requests recommended contents listed based on a user viewing history, a method for recommending content, and a method for displaying an image.

According to an aspect of an exemplary embodiment, there is provided a content recommendation apparatus configured to connect to an image display apparatus, including: a viewing history analyzer configured to collect viewing information of a user from the image display apparatus, generate a viewing history of the user using the collected viewing information, and analyze the generated viewing history; a content mapper configured to map recommended contents to the user according to a result of the analyzing, update the recommended contents, and map, as recommended content, content processed by one of the image display apparatus and a peripheral apparatus connected to the image display apparatus before one of an updating time and a time at which the user requests the recommended contents; and an image former configured to generate images of the updated recommended contents, provide the generated images to the image display apparatus in response to the user requesting the recommended contents, generate an image of the processed content, and provide the generated image to the image display apparatus.

The content mapper may be further configured to map at least one of a broadcast content currently being displayed by the image display apparatus and a broadcast content scheduled to be broadcast in the future, and the image former may be further configured to generate and provide images of the mapped broadcast contents.

The processed content may include at least one of broadcast content viewed by the user, content recorded by the peripheral apparatus, and video on demand (VOD) content accessed by the user through a VOD service, the he peripheral apparatus may be a personal video recorder, and the processed content may further include content of a genre similar to that of the broadcast content, the recorded content, or the VOD content.

The image former may be further configured to generate thumbnail images using a representative image of a main scene of each of the recommended contents and provide the generated thumbnail images as the generated images.

The image former may be further configured to generate a menu screen including at least one genre of the recommended contents which selectable by a user, provide the generated menu screen to the image display apparatus, and provide an image corresponding to the genre selected by the user.

The content mapper may be further configured to map link information linked to an external apparatus which stores the recommended contents, and update the mapped link information, and the content recommendation apparatus may further include a controller configured to control the content mapper to receive the recommended contents from the external apparatus based on the updated link information.

According to an aspect of another exemplary embodiment, there is provided a content recommendation method of a content recommendation apparatus configured to be connected to an image display apparatus, the method including: collecting viewing information of a user from the image display apparatus, generating a viewing history of the user, and analyzing the generated viewing history; mapping recommended contents to the user according to a result of the analyzing, updating the recommended contents, and mapping, as recommended content, content processed by one of the image display apparatus and a peripheral apparatus connected to the image display apparatus before one of an updating time and a time at which the user requests the recommended contents; and generating images of the updated recommended contents, providing the generated images to the image display apparatus in response to the user requesting the recommended contents, generating an image of the processed content, and providing the generated image to the image display apparatus.

The mapping the content may include mapping a broadcast content currently being displayed by the image display apparatus and a broadcast content schedule to be broadcast in the future, and the providing the generated images may include generating and providing images of the mapped broadcast contents.

The processed content may include at least one of broadcast content, content recorded by the peripheral apparatus, and video on demand (VOD) content used by the user using a VOD service, the peripheral apparatus is a personal video recorder, and the processed content may further include content of a genre which is similar to the broadcast content, the recorded content, or the VOD content.

The providing the generated images may include generating thumbnail images using a representative image of a main scene of each of the recommended contents, and providing the generated thumbnail images as the generated images.

The providing the generated images may include generating a menu screen including at least one genre of the recommended contents which is selectable by a user, transmitting the menu screen to the image display apparatus, and providing an image corresponding to a genre selected by the user.

The operation of updating the recommended contents may include mapping link information linked to an external apparatus storing the recommended contents, and updating the mapped link information, and the method may further include controlling the external apparatus to provide the recommended contents based on the updated link information.

According to an aspect of another exemplary embodiment, there is provided an image display method including: displaying, on a screen, a content image requested by a user; displaying the content image on one side of the screen in response to the user requesting recommended contents which are generated based on a viewing history of the user; and displaying images of the recommended contents around the content image displayed on the one side of the screen, wherein the recommended contents may include content processed by one of an image display apparatus and a peripheral apparatus connected to the image display apparatus before the user requests the recommended contents.

The recommended contents may include broadcast content scheduled to be broadcast in the future.

The processed content may include at least one of broadcast content, content recorded by the peripheral apparatus, and video on demand (VOD) content accessed by the user through a VOD service, the processed content may further include content of a genre similar to the broadcast content, the recorded content, or the VOD content, and the peripheral apparatus may include a personal video recorder.

The method may further include displaying a menu screen including at least one genre of the recommended contents which is selectable by the user, in response to the user requesting the recommended contents, and the displaying the images of the recommended contents may include displaying images of the recommended contents corresponding to the selected genre.

The displaying the images of the recommended contents may include displaying thumbnail images generated using a representative image of a main scene of each of the recommended contents.

In response to the user selecting one of the displayed images, recommended content corresponding to the selected image may be played back and displayed on the entire screen.

According to an aspect of anther exemplary embodiment, there is provided a non-transitory computer readable medium having recorded thereon a program, which when executed by a computer, causes the computer to execute a method including: generating a viewing history of a user based on collected viewing information of the user; selecting recommended contents based on the generated viewing history; generating thumbnail images corresponding to each of the recommended contents; and transmitting the thumbnail images to a display apparatus.

The collected viewing information may include content previously viewed by the user on the display apparatus.

The recommended contents may include at least one of a broadcast program viewed by the user, a broadcast program that is currently being broadcast, a broadcast program scheduled to be broadcast in the future, a content recorded by the user, and video-on-demand content.

Additional and/or other aspects and advantages of exemplary embodiments will be set forth in part in the description which follows and, in part, will be obvious from the description, or may be learned by practice of exemplary embodiments.

### BRIEF DESCRIPTION OF THE DRAWINGS

The above and/or other aspects will become more apparent by describing certain exemplary embodiments with reference to the accompanying drawings, in which:

FIG. 1 illustrates a content recommendation system according to an exemplary embodiment;

FIG. 2 illustrates an example of screen composition of a content recommendation service displayed on a screen of the image display apparatus shown FIG. 1;

FIG. 3 is a detailed block diagram of a configuration of the content recommendation apparatus shown in FIG. 1;

FIG. 4 illustrates a content recommendation process according to a first exemplary embodiment;

FIG. 5 illustrates a content recommendation process according to a second exemplary embodiment;

FIG. 6 is a flowchart of a method for recommending contents using the content recommendation apparatus according to an exemplary embodiment; and

FIG. 7 is a flowchart of a method for displaying an image according to an exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements, even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

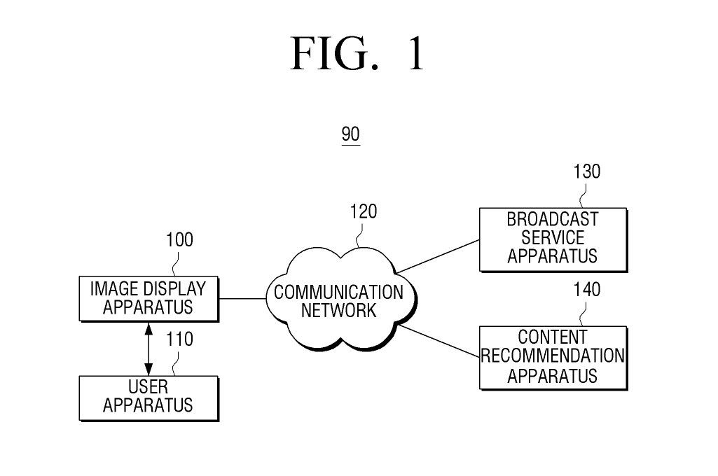

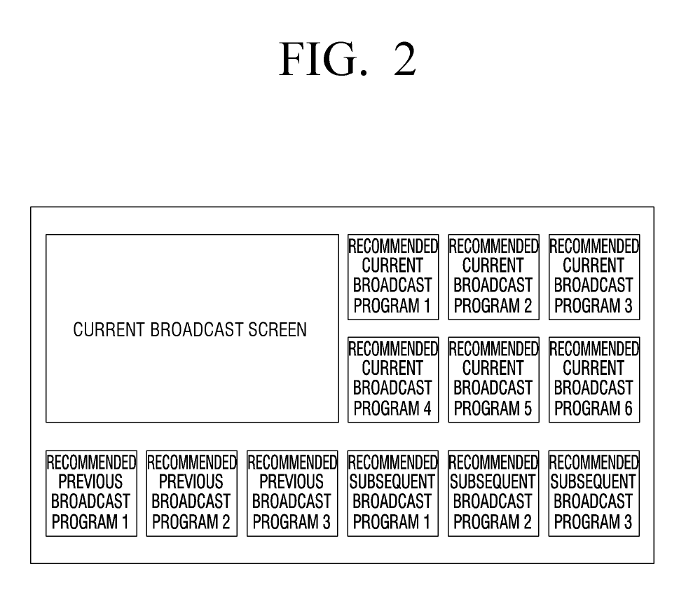

FIG. 1 illustrates a content recommendation system according to an exemplary embodiment, and FIG. 2 illustrates an example of a screen composition of a content recommendation service displayed on a screen of the image display apparatus shown FIG. 1.

With reference to FIG. 1, the content recommendation system 90 may include, in part or in whole, an image display apparatus 100, a user apparatus 110, a communication network 120, a broadcast service apparatus 130, and a content recommendation apparatus 140.

Including the components in part or in whole indicates omitting some components such as the user apparatus 110 or integrating some components such as the user apparatus 110 into another component such as the image display apparatus 100. For convenience, the content recommendation system 90 is explained with reference to all of the above components.

The image display apparatus 100 according to an exemplary embodiment may be a touch-screen type image display apparatus, a spontaneous emission image display apparatus such as an organic light emitting diode (OLED), or a non-emissive image display apparatus such as a liquid crystal display (LCD). The image display apparatus 100 may be a TV or a display apparatus such as a computer and a mobile phone. The non-emissive display apparatus is an image display apparatus with a backlight unit to provide light. The backlight unit may include a light emitting diode (LED).

The image display apparatus 100 displays a content image requested by a user, and transmits viewing information of the user who views the content image to the content recommendation apparatus 140 over the communication network 120. For example, supposing that the user watches a program on channel 7 on the image display apparatus 100. When the user requests the program, the image display apparatus 100 provides the content recommendation apparatus 140 with broadcast channel information and time information as the viewing information together with apparatus information. The time information may include a date and a time zone. In addition, when providing the content recommendation apparatus 140 with the apparatus information, the image display apparatus 100 may request a resident registration number or a phone number from the user and provide the content recommendation apparatus 140 with the resident registration number or the phone number as user information. In addition, when the image display apparatus 100 transmits the channel information and the time information to the content recommendation apparatus 140, the content recommendation apparatus 140 may receive information regarding the program from the broadcast service apparatus 130 and generate a viewing history. Accordingly, in the present exemplary embodiment, how the image display apparatus 100 provides the content recommendation apparatus 140 with the viewing information in order for the content recommendation apparatus 140 to generate a viewing history according to users is not limited thereto.

In addition, the image display apparatus 100 may request recommended contents listed in the content recommendation apparatus 140 based on the user's viewing history, and receive the requested recommended contents from the content recommendation apparatus 140. When the broadcast service apparatus 130 is linked to the content recommendation apparatus 140 using link information, the image display apparatus 100 may receive recommended contents from the broadcast service apparatus 130. The received recommended contents may be displayed in a thumbnail image format around a broadcast screen that the user currently views, as shown in FIG. 2. The recommended contents may include broadcast contents related to a program viewed by the user in the past, recorded contents provided by the user recording a previously shown program, and video-on-demand (VOD) contents which the user accesses through a VOD service. The image display apparatus 100 may display a currently shown program on the image display apparatus 100, an image regarding a program to be subsequently shown, and an image regarding a previously shown program based on the time at which the user requests recommended contents.

Before displaying images regarding the recommended contents, the image display apparatus 100 may enable the user to select a program genre. For example, in order for the user to select a genre, the image display apparatus 100 provides a list screen or a menu screen. The list screen simply lists items according to genres. The menu screen is formed by providing a visual image. When the user selects, for example, a soap opera genre using the list screen or the menu screen, the image display apparatus 100 displays, on the screen images of a previously shown program, a currently shown program, and a subsequent program to be shown related to soap operas. The image display apparatus 100 may determine that a genre of a broadcast program which is currently being viewed by the user is a genre that the user wants. In other words, when the user requests recommended contents while watching a sportscast, the image display apparatus 100 may provide the content recommendation apparatus 140 with viewing information regarding the currently watched sportscast as genre information.

Among the recommended images displayed in diverse methods, the image display apparatus 100 receives recommended content corresponding to an image selected by the user from the broadcast service apparatus 130 or the content recommendation apparatus 140, and displays the recommended content on the screen. At this time, the image display apparatus 100 may receive and display the recommended content in real time, or may store, run, and display the recommended content.

The user apparatus 110 may be a peripheral of the image display apparatus 100, including a video cassette recorder (VCR), a video tape recorder (VTR), and a personal video recorder (PVR). The user apparatus 110 may further include a camcorder. When the user apparatus 110 is a PVR, the user apparatus 110 may be integrated into the image display apparatus 100. The PVR enables the user to watch TV corresponding to the user's taste regardless of a program schedule of a broadcasting station, and has an advertisement skipping function so that when an advertisement is shown on TV, the user may watch a program previously input into a hard disk, such as a music video or a baseball game highlight, instead of the advertisement, by pressing a button. In addition, the PVR may record a digital image of a camcorder or a digital video disk (DVD), and be connected to a personal computer (PC) for editing. The user apparatus 110 may record a program that the user wants, and transmit the recorded program to the image display apparatus 100, and the image display apparatus 100 may transmit the recorded content to the content recommendation apparatus 140. In addition, the image display apparatus 100 may transmit image content provided by a camcorder to the content recommendation apparatus 140. Thus, the image display apparatus 100 may display an image relating to data photographed by the user as a recommended image so that the user may enjoy a personalized display.

The communication network 120 may include a wire communication network and a wireless communication network. The wire communication network includes an internet network such as a cable network and a public switched telephone network (PSTN). The wireless communication network includes code division multiple access (CDMA), wideband code division multiple access (WCDMA), global standard for mobile communication (GSM), evolved packet core (EPC), long term evolution (LTE), a wireless broadband internet (WiBro) network, etc. Accordingly, when the communication network 120 is the wire communication network, an access point may access a telephone exchange office, or when the communication network 120 is the wired communication network, an access point may process data by accessing a GPRS support node (SGSN) or a gateway GPRS support node (GGSN) which is operated by a mobile carrier or by accessing diverse repeaters such as base station transmission (BTS) repeaters, NodeB repeaters, e-NodeB repeaters, and the like.

In addition, the communication network 120 may include a small base station (AP) such as a femto base station and a pico base station which are typically installed in a building. The femto base station and pico base station are divided according to how many image display apparatuses can access the base station. The AP includes a local area communication module to perform local area communication, such as Zigbee and wireless fidelity (Wi-Fi), with the image display apparatus 100. In the exemplary embodiments, the local area communication may be performed in diverse standards of radio frequency (RF) and ultra-wideband (UWB) such as Bluetooth, Zigbee, IrDA, ultra high frequency (UHF), and very high frequency (VHF). Accordingly, the AP extracts a location of a data packet, designates an optimal communication path for the extracted location, and transmits the data packet to a subsequent apparatus, for example, to the image display apparatus 100 along the designated communication path.

The broadcast service apparatus 130 includes, for example, a broadcasting server operated by a broadcasting station. The broadcast service apparatus 130 provides broadcast content, that is a broadcast signal of a program, of a broadcast channel selected by the user. In addition, when the user requests a broadcast program schedule from the image display apparatus 100, the broadcast service apparatus 130 may provide additional information regarding the broadcast program schedule. Furthermore, the broadcast service apparatus 130 may provide recommended contents requested by the content recommendation apparatus 140. In other words, when the content recommendation apparatus 140 builds recommended contents based on a viewing history of the user of the image display apparatus 100, the broadcast service apparatus 130 provides corresponding content requested by the content recommendation apparatus 140. However, when the content recommendation apparatus 140 only forms a link relationship using link information, the broadcast service apparatus 130 may not provide the content recommendation apparatus 140 with the corresponding content.

When the content recommendation apparatus 140 requests a representative image indicating a main scene of each recommended content in order to form an image of the recommended content, the broadcast service apparatus 130 may provide the content recommendation apparatus 140 with the representative image. In this case, the content recommendation apparatus 140 may form a thumbnail image for the representative image and a link with the broadcast service apparatus 130. When the user selects the thumbnail image, the broadcast service apparatus 130 may directly provide the image display apparatus 100 with broadcast content linked to the thumbnail image.

The content recommendation apparatus 140 collects viewing information regarding the user from the image display apparatus 100, and generates a viewing history for each user using the collected viewing information. For example, the content recommendation apparatus 140 may form a viewing history of user A according to the date and, by extension, the time based on accumulated viewing information regarding user A. In other words, the content recommendation apparatus 140 analyzes viewing patterns of user A, such as that user A watches a soap opera genre program on weekdays and watches a variety show on weekends. As a result, when the user requests recommended contents on a weekday, more precisely, on a particular date and in a particular time zone, the content recommendation apparatus 140 provides the image display apparatus 100 with images of the recommended contents based on the viewing history of the user, thereby recommending contents that the user wants. The viewing history of the user may include a viewing history regarding a VOD service.

For example, supposing that the user requests recommended contents at 6 p.m. on Saturday, the content recommendation apparatus 140 may recommend contents in diverse methods. For example, the content recommendation apparatus 140 may recommend broadcast contents of programs shown a week ago at 6 p.m. on the previous Saturday, and may also recommend broadcast contents of currently shown programs and subsequent programs to be shown. At this time, the recommended broadcast contents may be provided according to a genre selected by the user. To do so, when the user selects a genre through a menu screen provided on the image display apparatus 100, the content recommendation apparatus 140 may only recommend broadcast contents of the selected genre. Furthermore, even if a menu screen is not provided, the content recommendation apparatus 140 may determine which program the user is currently watching when requesting recommended contents and recommend only broadcast contents of the same genre as the currently shown program.

Even if a genre is not selected, the content recommendation apparatus 140 may still recommend contents at random based on a viewing history of the user. For example, when the user primarily enjoys watching a variety show, but also sometimes enjoys watching a soap opera at 6 p.m. on Saturday, the content recommendation apparatus 140 may recommend broadcast contents by giving more weight to variety shows than to soap operas. In other words, when the content recommendation apparatus 140 provides ten of the previously shown broadcast contents as recommended contents, the content recommendation apparatus 140 may select five variety shows and two soap operas and provide thumbnail images of the recommended contents. The remaining three recommended contents may be programs to be subsequently shown.

Furthermore, the content recommendation apparatus 140 may receive content recorded by the user using the user apparatus 110, such as a PVR from the image display apparatus 100, and include the recorded content in the viewing history. The content recommendation apparatus 140 may give priority to the recorded content so as to preferentially include the recorded content in the recommended contents. For example, supposing content recorded by the user is a soap opera broadcast program recorded 5 days ago. When the user requests recommended contents of a soap opera genre, the content recommendation apparatus 140 may include the recorded content in a recommended list first, and then include the remaining contents in the recommended list based on a viewing history of the user.

As described above, the user of the image display apparatus 100 may receive a recommendation for contents of currently shown programs and subsequent programs to be shown, and also receive a recommendation for contents of previously shown programs regardless of whether the contents are recorded contents or broadcast contents. Therefore, the user's convenience in watching a program may increase. In other words, in the related art, when the user wishes to watch a previously shown program, the user has to search for and run a program that the user wants. However, in the exemplary embodiments, such an inconvenient process is not necessary.

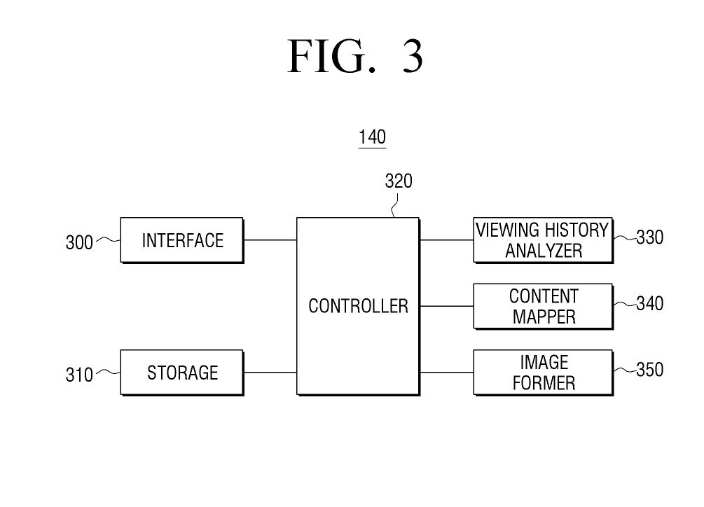

FIG. 3 is a detailed block diagram of a configuration of the content recommendation apparatus 140 shown in FIG. 1.

With reference to FIGS. 1 and 3, the content recommendation apparatus 140 according to an exemplary embodiment may include, in part or in whole, an interface 300, a storage 310, a controller 320, a viewing history analyzer 330, a content mapper 340, and an image former 350.

As set forth above, including the components in part or in whole indicates omitting some components or integrating some components into another component. For convenience, the content recommendation apparatus 140 is explained to include all of the above components.

Another exemplary embodiment may disclose that any of the interface 300, the storage 310, the controller 320, the viewing history analyzer 330, the content mapper 340, and the image former 350 may include at least one of a processor, a hardware module, or a circuit for performing their respective functions.

The interface 300 includes a communication interface, and may further include a user interface to input information. When viewing information of the user is transmitted from the image display apparatus 100, the interface 300 transmits the viewing information to the viewing history analyzer 330. When the image display apparatus 100 requests recommended contents, the interface 300 provides, for example, thumbnail images of the recommended contents provided by the image former 350, and may provide recommended content which is stored in the content mapper 340 and is selected by the user through the thumbnail image, or provide the broadcast service apparatus 130 with information so that content linked by the content mapper 340 may be provided from the broadcast service apparatus 130. During this process, the interface 300 may perform further operations such as information conversion to compress the thumbnail images and to decode representative images which are compressed and provided by the broadcast service apparatus 130.

The storage 310 may temporarily store overall information or data processed by the content recommendation apparatus 140, and output the temporarily stored data under the control of the controller 320. For example, when the image display apparatus 100 provides viewing information of the user, the storage 310 temporarily stores the viewing information, and provides the viewing history analyzer 330 with the viewing information under the control of the controller 320. The storage 310 temporarily stores and provides diverse data as described above.

The controller 320 controls the overall operation of the interface 300, the storage 310, the viewing history analyzer 330, the content mapper 340, and the image former 350 in the content recommendation apparatus 140. For example, the controller 320 reads out viewing information of the user which is temporarily stored in the storage 310 and provides the viewing history analyzer 330 with the viewing information. In addition, when the user of the image display apparatus 100 requests recommended contents, the controller 320 controls such that an image provided by the image former 350 is transmitted to the image display apparatus 100 through the interface 300. In addition, the controller 320 receives content recorded by the user from the image display apparatus 100 or broadcast content from the broadcast service apparatus 130, and transmits the received content to the content mapper 340.

The viewing history analyzer 330 collects viewing information of the user, generates a viewing history using the collected viewing information, and analyzes the generated viewing history so that a viewing pattern for each user may be determined. In other words, the viewing history analyzer 330 accumulates and stores input viewing information, and generates a viewing history based on statistics. For example, the viewing history analyzer 330 may separate viewing information from Monday to Sunday, and analyze the viewing information to determine, for example, which program the user viewed on which day of the week. For example, when the user enjoyed watching variety shows of 3 broadcasting stations on Saturday and, by extension, at 6 p.m., and in particular, enjoyed watching a variety show on channel 7 of broadcasting station KBS, the viewing history analyzer 330 analyzes a viewing history regarding this situation. Subsequently, the viewing history analyzer 330 provides the content mapper 340 with the analysis results.

The content mapper 340 maps recommended contents to each user based on the analysis results provided by the viewing history analyzer 330. The content mapper 340 may set link information regarding recommended contents. In other words, when user A enjoyed watching a variety show on channel 7 of broadcasting station KBS on Saturday, the content mapper 340 may receive corresponding content from the broadcast service apparatus 130 and maps the content to user A. Alternatively, the content mapper 340 may set link information regarding the corresponding content of the broadcast service apparatus 130.

In such a set state, the content mapper 340 may update the mapped content based on the analysis results of the viewing history analyzer 330 which change according to successively provided viewing information of the user. The updating may be performed periodically, or be performed whenever the user requests recommended contents. In this process, as the analysis results of the viewing history analyzer 330, when the viewing pattern of user A has changed from the variety show on channel 7 on Saturday to a variety show on channel 11 of broadcasting station MBC, the content mapper 340 maps and stores corresponding content as recommended content.

The content mapper 340 may map and store diverse contents according to the analysis results of the viewing history of the user. For example, when the user requests recommended contents on Saturday, the content mapper 340 may map contents of diverse genres that the user enjoyed watching on Saturday, regardless of a particular time zone. In this process, for example, when the user provides content recorded by himself or herself, the content mapper 340 may map and preferentially store the recorded content as long as the recorded content is included in a predetermined time range. In addition, the content mapper 340 may provide the image former 350 with mapping information regarding the mapped contents or representative images of recommended contents.

The image former 350 generates an image of content, that is a recommended image, based on the mapping information of the content mapper 340. In other words, the image former 350 may receive information regarding recommended contents to recommend to user A on Saturday from the content mapper 340, receive representative images of the recommended contents from the broadcast service apparatus 130 based on corresponding mapping information, and generate recommended images. Alternatively, the image former 350 may receive recommended images directly from the content mapper 340. The recommended images may be thumbnail images.

Subsequently, the image former 350 provides, by the user's request, the image display apparatus 100 with thumbnail images generated for each user as recommended images for the recommended contents under the control of the controller 320. When the user selects one of the thumbnail images, the controller 320 may determine the selected thumbnail image, and provide the image display apparatus 100 with content which is mapped and stored in the content mapper 340. If this content is linked to the broadcast service apparatus 130, the controller 320 may request that the broadcast service apparatus 130 provide the image display apparatus 100 with the content. Based on the above description, the controller 320 according to an exemplary embodiment may include a determiner to determine recommended content selected by the user. The determiner may be provided separately from the controller 320. Accordingly, the controller 320 may perform the corresponding operation according to the determination results of the determiner.

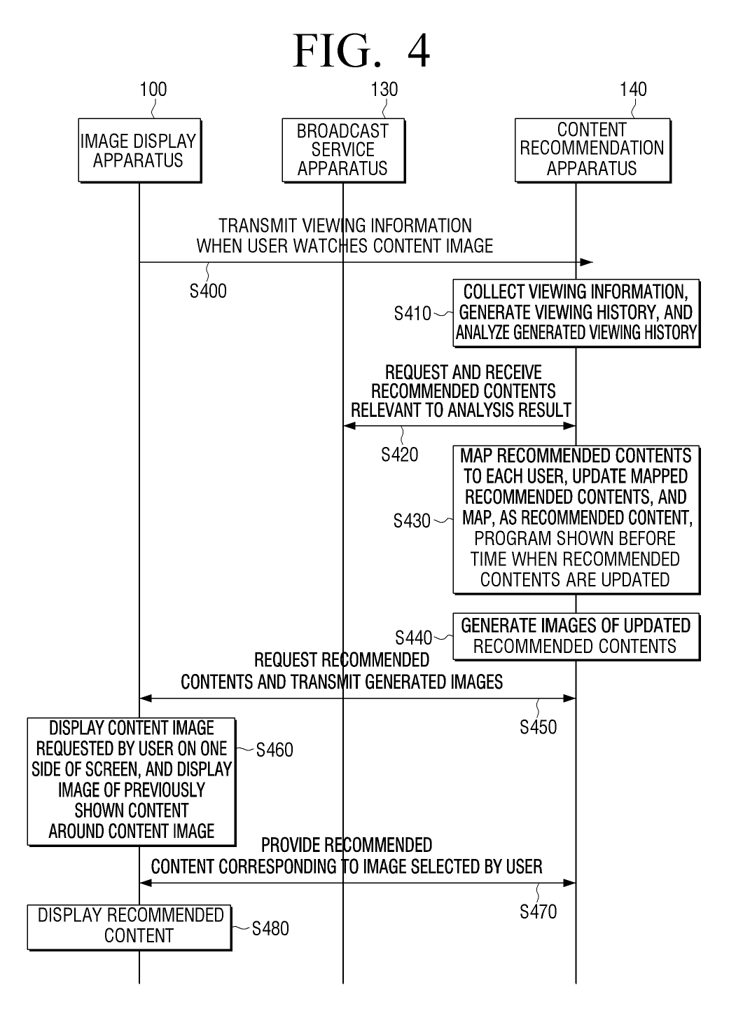

FIG. 4 illustrates a content recommendation process according to a first exemplary embodiment.

With reference to FIG. 4, together with FIG. 1 for convenient description, the image display apparatus 100 according to this exemplary embodiment transmits viewing information to the content recommendation apparatus 140 when the user watches a content image such as a broadcast program (S400). When the content image is a broadcast program, channel information and program information may be transmitted as the viewing information. When transmitting the viewing information, the image display apparatus 100 may transmit the viewing information together with apparatus information, and also transmit user information such as a resident registration number and a phone number of the user. When transmitting the channel information, the image display apparatus 100 may transmit time information. Based on the channel information and the time information, the content recommendation apparatus 140 may receive a program schedule from the broadcast service apparatus 130, and acquire the program information from the received program schedule. Accordingly, this exemplary embodiment does not limit how to use the viewing information.

The content recommendation apparatus 140 collects the viewing information received from the image display apparatus 100, generates a viewing history of each user using the collected viewing information, and analyzes the generated viewing history (S410). In other words, the content recommendation apparatus 140 may analyze which content images the user watched in the past, and analyze a viewing pattern such as which content the user watches with regard to currently shown programs or subsequent programs to be shown based on the analysis.

According to the analysis results, the content recommendation apparatus 140 requests contents relevant to the analysis results from the broadcast service apparatus 130, and receives the requested contents (S420).

Subsequently, the content recommendation apparatus 140 maps the received contents to each user, and updates the mapped recommended contents (S430). During this process, the content recommendation apparatus 140 may map as recommended content a program shown at least before the time when the recommended contents are updated, or may map as recommended content a program shown at least before the time when the user requests the recommended contents.

Subsequently, the content recommendation apparatus 140 generates images of the updated recommended contents, for example, thumbnail images (S440). If the recommended contents are updated at the time when the user requests the recommended contents, the images may be generated after the updating.

When the user of the image display apparatus 100 requests the recommended contents, the content recommendation apparatus 140 transmits the images of the updated recommended contents to the image display apparatus 100 (S450).

Subsequently, the image display apparatus 100 displays a content image of a currently broadcast content on one side of the screen, and displays an image of the previously shown content around the content image (S460).

When the user selects an image of recommended content that the user wants, the image display apparatus 100 provides the content recommendation apparatus 140 with image information of the selected content, and the content recommendation apparatus 140 provides the image display apparatus 100 with the recommended content corresponding to the selected image so that the image display apparatus 100 may run and display the recommend content on the screen (S470 and S480).

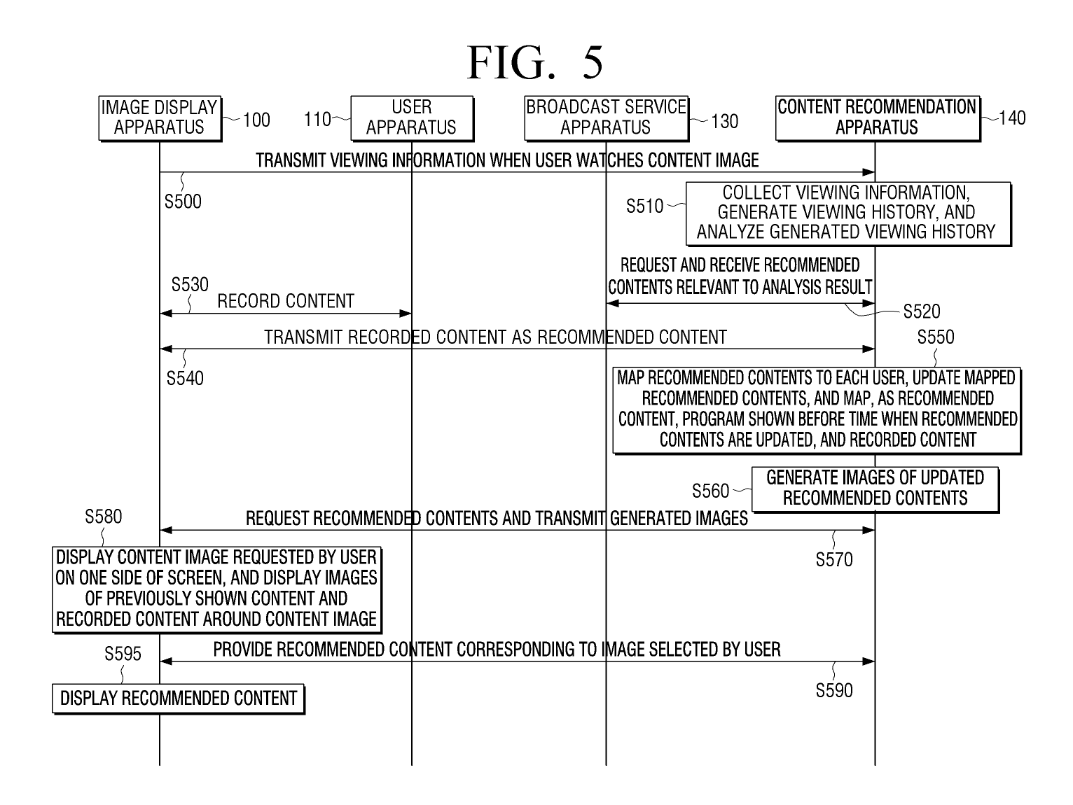

FIG. 5 illustrates a content recommendation process according to a second exemplary embodiment.

With reference to FIG. 5, together with FIG. 1 for convenient description, the content recommendation process according to the second exemplary embodiment is not significantly different from that according to the first exemplary embodiment described with reference to FIG. 4.

However, by the user's request, the user apparatus 110 according to this exemplary embodiment records broadcast content displayed on the image display apparatus 100 or image content personally manufactured by the user using a camcorder, and transmits the recorded content to the content recommendation apparatus 140 through the image display apparatus 100 (S530 and S540).

Subsequently, when mapping recommended contents to each user, the content recommendation apparatus 140 maps the recorded content to the user, and updates the recommended contents (S550). When the user sets preferentially providing the recorded content provided by the user as recommended content, the content recommendation apparatus 140 may preferentially map the recorded content to the user.

However, the recorded content may only be mapped to the user if the recorded content is included within a predetermined period of time set by the user. In other words, when the user requests that only content which was recorded within the last 7 days be included in a recommended list, content which was recorded 8 or more days ago is excluded from the recommended list in spite of having priority.

According to this process, the user of the image display apparatus 100 may receive a recommendation for the content recorded by the user (S570). When the user selects a recommended image corresponding to the recorded content on the screen, the user may play back and watch the recorded content that the user wants (S570, S580, S590, and S595).

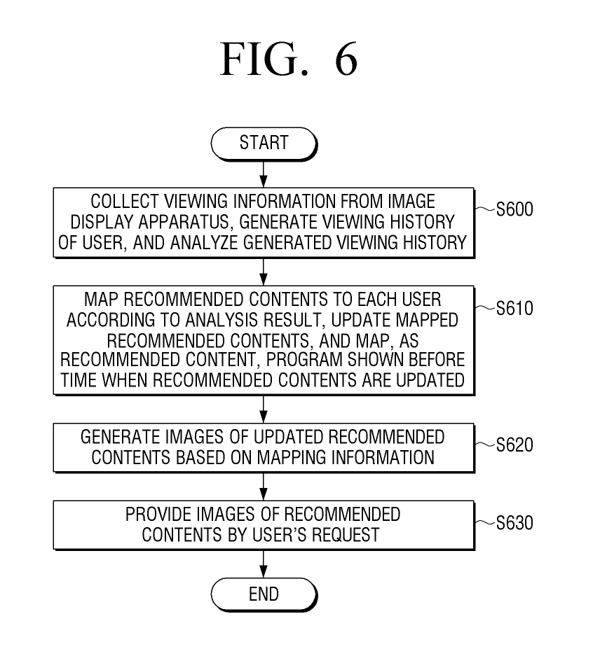

FIG. 6 is a flowchart of a method for recommending contents using the content recommendation apparatus 140 according to an exemplary embodiment.

With reference to FIG. 6, together with FIG. 1 for convenient description, the content recommendation apparatus 140 according to this exemplary embodiment collects viewing information of the user from the image display apparatus 100, generates a viewing history of the user, and analyzes the generated viewing history (S600). The viewing history may be a plurality of pieces of collected viewing information. At this time, the viewing history may be a set of viewing information according to the day of the week. In addition, by analyzing the viewing history, the content recommendation apparatus 140 may acquire information regarding a viewing pattern of the user such as which program of which broadcasting station the user viewed on each day of the week.

According to the analysis results, the content recommendation apparatus 140 maps recommended contents for each user, and updates the mapped recommended contents (S610). At this time, the content recommendation apparatus 140 may map as recommended content a broadcast program shown at least before the time when the recommended contents are updated.

‘At least before’ indicates that a broadcast program shown in the past is preferentially mapped as the recommended content, and a currently shown program and a subsequent program to be shown may also be mapped as the recommended contents. In addition, according to the exemplary embodiments, the updating time may be the time when the user requests the recommended contents.

Subsequently, the content recommendation apparatus 140 generates images of the updated recommended contents based on mapping information (S620). To do so, the content recommendation apparatus 140 may request representative images to form the corresponding images, that is, images representing main scenes, from the broadcast service apparatus 130. Since detailed description thereof has been provided above, the description is not repeated.

When the user requests the recommended contents through the image display apparatus 100, the content recommendation apparatus 140 provides the images of the recommended contents, for example, thumbnail images (S630).

Furthermore, the content recommendation apparatus 140 may provide content corresponding to an image selected by the user. The content may be provided by the broadcast service apparatus 130 linked to the content recommendation apparatus 140. This exemplary embodiment does not limit how to provide the content corresponding to the selected image.

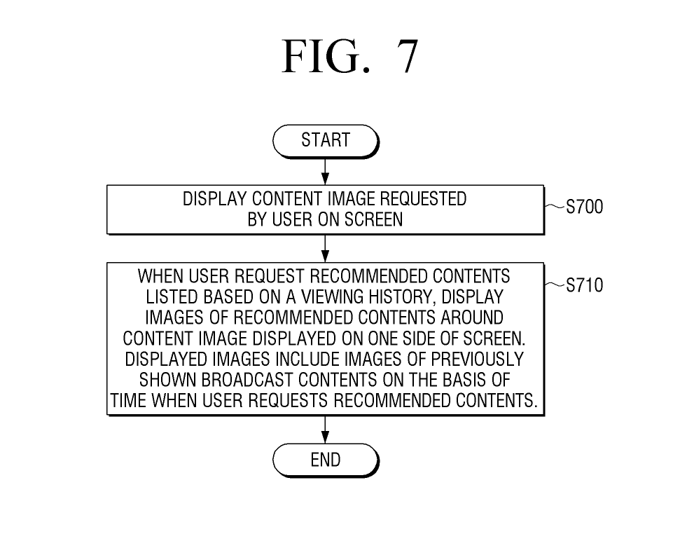

FIG. 7 is a flowchart of a method for displaying an image according to an exemplary embodiment.

With reference to FIG. 7, together with FIG. 1 for convenient description, the image display apparatus 100 according to the exemplary embodiment displays a content image requested by the user, for example, an image of a particular broadcast program on the screen (S700).

When the user requests recommended contents listed based on a viewing history, the image display apparatus 100 displays the currently watched content image on one side of the screen, and displays images of the recommended contents around the content image (S710). The displayed images may include images of previously shown broadcast contents on the basis of the time when the user requests the recommended contents. In addition, the images of the recommended contents may include an image of content recorded by the user.

The image display apparatus 100 may further display a menu screen to display the recommended contents according to genres. When the user selects a sports genre through the menu screen, the image display apparatus 100 may display thumbnail images of recommended contents corresponding to the sports genre.

Subsequently, the image display apparatus 100 receives content corresponding to an image selected by the user, and displays the content on the entire screen.

Although the components of the exemplary embodiment are described to be combined or to be operated by combination, the exemplary embodiments is not limited thereto. Within the scope of the purpose of the exemplary embodiments, one or more components may be selectively combined. In addition, each of the components may be implemented with independent hardware, or a portion of or all of the components may be selectively combined and be implemented with a computer program having a program module which performs a portion of or all of the functions combined in one or more pieces of hardware. The codes and the code segments which compose the computer program may easily be inferred by those skilled in the art. The computer program is stored in a non-transitory computer readable medium and is read and run by a computer so that the exemplary embodiments may be implemented.

The non-transitory computer readable medium is a medium which stores data semi-permanently and is readable by devices. More specifically, the computer program may be stored in non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the inventive concept as defined by the appended claims, and many alternatives, modifications, and variations will be apparent to those skilled in the art.

What is claimed is:

1. A content recommendation apparatus configured to connect to an image display apparatus, comprising:
a viewing history analyzer configured to collect viewing information of a user from the image display apparatus, generate a viewing history of the user using the collected viewing information, and analyze the generated viewing history;
a content mapper configured to map recommended contents to the user according to a result of the analyzing, update the recommended contents, and map, as recommended content, content processed by one of the image display apparatus and a peripheral apparatus connected to the image display apparatus before one of an updating time and a time at which the user requests the recommended contents; and
an image former configured to generate images of the updated recommended contents, provide the generated images to the image display apparatus in response to the user requesting the recommended contents, generate an image of the processed content, and provide the generated image to the image display apparatus.

2. The content recommendation apparatus as claimed in claim 1, wherein the content mapper is further configured to map at least one of a broadcast content currently being displayed by the image display apparatus and a broadcast content scheduled to be broadcast in the future, and
wherein the image former is further configured to generate and provide images of the mapped broadcast contents.

3. The content recommendation apparatus as claimed in claim 1, wherein the processed content comprises at least one of broadcast content viewed by the user, content recorded by the peripheral apparatus, and video on demand (VOD) content accessed by the user through a VOD service,
wherein the peripheral apparatus is a personal video recorder, and
wherein the processed content further comprises content of a genre similar to that of the broadcast content, the recorded content, or the VOD content.

4. The content recommendation apparatus as claimed in claim 1, wherein the image former is further configured to generate thumbnail images using a representative image of a main scene of each of the recommended contents and provide the generated thumbnail images as the generated images.

5. The content recommendation apparatus as claimed in claim 1, wherein the image former is further configured to generate a menu screen comprising at least one genre of the recommended contents which selectable by a user, provide the generated menu screen to the image display apparatus, and provide an image corresponding to the genre selected by the user.

6. The content recommendation apparatus as claimed in claim 1, wherein the content mapper is further configured to map link information linked to an external apparatus which stores the recommended contents, and update the mapped link information, and
wherein the content recommendation apparatus further comprises a controller configured to control the content mapper to receive the recommended contents from the external apparatus based on the updated link information.

7. A content recommendation method of a content recommendation apparatus configured to be connected to an image display apparatus, the method comprising:
collecting viewing information of a user from the image display apparatus, generating a viewing history of the user, and analyzing the generated viewing history;
mapping recommended contents to the user according to a result of the analyzing, updating the recommended contents, and mapping, as recommended content, content processed by one of the image display apparatus and a peripheral apparatus connected to the image display apparatus before one of an updating time and a time at which the user requests the recommended contents; and
generating images of the updated recommended contents, providing the generated images to the image display apparatus in response to the user requesting the recommended contents, generating an image of the processed content, and providing the generated image to the image display apparatus.

8. The method as claimed in claim 7, wherein the mapping the content comprises mapping a broadcast content currently being displayed by the image display apparatus and a broadcast content schedule to be broadcast in the future, and
wherein the providing the generated images comprises generating and providing images of the mapped broadcast contents.

9. The method as claimed in claim 7, wherein the processed content comprises at least one of broadcast content, content recorded by the peripheral apparatus, and video on demand (VOD) content used by the user using a VOD service,
wherein the peripheral apparatus is a personal video recorder, and
wherein the processed content further comprises content of a genre which is similar to the broadcast content, the recorded content, or the VOD content.

10. The method as claimed in claim 7, wherein the providing the generated images comprises generating thumbnail images using a representative image of a main scene of each of the recommended contents, and providing the generated thumbnail images as the generated images.

11. The method as claimed in claim 7, wherein the providing the generated images comprises generating a menu screen comprising at least one genre of the recommended contents which is selectable by a user, transmitting the menu screen to the image display apparatus, and providing an image corresponding to a genre selected by the user.

12. The method as claimed in claim 7, wherein the operation of updating the recommended contents comprises mapping link information linked to an external apparatus storing the recommended contents, and updating the mapped link information, and
wherein the method further comprises controlling the external apparatus to provide the recommended contents based on the updated link information.

13. An image display method comprising:
displaying, on a screen, a content image requested by a user;
displaying the content image on one side of the screen in response to the user requesting recommended contents which are generated based on a viewing history of the user; and
displaying images of the recommended contents around the content image displayed on the one side of the screen,
wherein the recommended contents comprise content processed by one of an image display apparatus and a peripheral apparatus connected to the image display apparatus before the user requests the recommended contents.

14. The method as claimed in claim 13, wherein the recommended contents comprise broadcast content scheduled to be broadcast in the future.

15. The method as claimed in claim 13, wherein the processed content comprises at least one of broadcast content, content recorded by the peripheral apparatus, and video on demand (VOD) content accessed by the user through a VOD service,
wherein the processed content further comprises content of a genre similar to the broadcast content, the recorded content, or the VOD content, and
wherein the peripheral apparatus comprises a personal video recorder.

16. The method as claimed in claim 13, further comprising:
displaying a menu screen comprising at least one genre of the recommended contents which is selectable by the user, in response to the user requesting the recommended contents,
wherein the displaying the images of the recommended contents comprises displaying images of the recommended contents corresponding to the selected genre.

17. The method as claimed in claim 13, wherein the displaying the images of the recommended contents comprises displaying thumbnail images generated using a representative image of a main scene of each of the recommended contents.

18. The method as claimed in claim 13, wherein in response to the user selecting one of the displayed images, recommended content corresponding to the selected image is played back and displayed on the entire screen.

19. A non-transitory computer readable medium having recorded thereon a program, which when executed by a computer, causes the computer to execute a method comprising:
generating a viewing history of a user based on collected viewing information of the user;
selecting recommended contents based on the generated viewing history;
generating thumbnail images corresponding to each of the recommended contents; and
transmitting the thumbnail images to a display apparatus.

20. The non-transitory computer readable medium of claim 19, wherein the collected viewing information comprises content previously viewed by the user on the display apparatus.

21. The non-transitory computer readable medium of claim 19, wherein the recommended contents comprise at least one of a broadcast program viewed by the user, a broadcast program that is currently being broadcast, a broadcast program scheduled to be broadcast in the future, a content recorded by the user, and video-on-demand content.
